(19) United States
(12) Patent Application Publication
(10) Pub. No.: US 2022/0335536 A1
(43) Pub. Date: Oct. 20, 2022

(54) SYSTEMS AND METHODS FOR LOCAL AND CLOUD-BASED TAX DETERMINATION OPERATIONS

(71) Applicant: Thomson Reuters Enterprise Centre GmbH, Zug (CH)

(72) Inventors: Christopher Reich, Portland, OR (US); Carl Davis, Tigard, OR (US); Ray Grove, Prosper, TX (US); Anu Dodda, Oakville (CA); Emre Caglar, Etobicoke (CA); Vitaly Tomlin, Gilford (CA); Pankaj Joshi, Plano, TX (US); Debraj Roy, Brampton (CA); Paul Shadbolt, Scarborough (CA)

(21) Appl. No.: 17/722,231

(22) Filed: Apr. 15, 2022

Related U.S. Application Data
(60) Provisional application No. 63/175,671, filed on Apr. 16, 2021.

(51) Int. Cl. G06Q 40/00; G06Q 20/38; G06Q 20/40

(52) U.S. Cl. CPC G06Q 40/10; G06Q 20/389; G06Q 20/401

(57) ABSTRACT

Aspects of the present disclosure provide systems, methods, apparatus, and computer-readable storage media that support local and cloud-based tax determination operations. In some examples, a transaction system may execute a local tax engine to enable localized tax calculation services in a lightweight footprint while still achieving one or more benefits of a cloud-based system (e.g., technical support and automatic updates of software and tax content). As a result, some aspects of the present disclosure may enable a “full power” tax engine that is local to a transactional system, such as an edge device, while also enabling the tax engine to automatically sync back to a cloud-based system, such as to receive one or more of a configuration update, a software release, a software update, or updated tax content. Further, the transaction system may transmit results of tax calculations to the cloud-based system, such as for reporting, compliance, or both.

### CROSS-REFERENCE TO RELATED APPLICATIONS

The present application claims the benefit of priority from U.S. Provisional Patent Application No. 63/175,671, filed Apr. 16, 2021 and entitled “INDIRECT TAX EDGE CALCULATION SERVICE,” the disclosure of which is incorporated by reference herein in its entirety.

### TECHNICAL FIELD

The present disclosure relates generally to electronic devices. More particularly, aspects of the present disclosure relate to electronic devices that perform local and cloud-based tax determination operations.

### BACKGROUND

Electronic devices enable a wide variety of transactions, such as sales of goods, sales of services, and other business transactions. A business that performs a transaction may be subject to collection of taxes from a customer at the time of the transaction, which may be referred to as indirect taxes. The business may subsequently remit such taxes to one or more taxing authorities.

Calculation, collection, and remittance of indirect taxes may introduce strain or loading to devices or networks. For example, a single transaction may be subject to multiple taxes (such as state, federal, city, or municipal taxes). Further, the amount of each tax may be determined based on a variety of parameters or variables, such as one or more of a ship-from location, a ship-to location, a type of product or service, or an exemption status of the business, or an exemption status of the consumer. Businesses may be responsible for accurately calculating, collecting, and remitting such taxes to the appropriate taxing authorities, and in some cases, significant penalties may be imposed if the tax collected or remitted is inaccurate.

Due the complex and dynamic nature of tax regulations, many businesses rely on technology to more accurately and efficiently calculate, collect, and remit taxes. Some businesses may rely on tax applications that are managed and supported locally (commonly known as “on premise”) and which may be close to the transactional systems used by the businesses to conduct transactions. For example, a tax application and a transaction system may be located within a data center of a business. As a result, a tax application may be relatively “close” to the transaction system of a business (e.g., by being in a common geographic location or by being included in a common enterprise network). By locating a tax application close to a transaction system, a response to a tax calculation request may be relatively fast.

Some businesses may adopt a cloud-based or software as a service (SaaS) approach to various operations, such as tax calculation. A cloud-based or SaaS approach may enable a business to “offload” tax calculation to a third party service, which may enable the business to avoid maintenance and other operations. The third party service may be hosted in a different geographic location than the transaction system of the business. As a result, a response to a tax calculation request may be relatively slow and may be subject to latency, delays, or outages in some cases. Further, network loading may be increased by increasing a number of messages transmitted to and received from outside the enterprise network of the business. In some cases, a business may lose a customer or sale due to a large wait time during tax calculation. As a result, some businesses may avoid cloud-based or SaaS approaches.

Some businesses may utilize a static rate file instead of a third-party service. The static rate file may indicate tax rates used by the businesses to calculate taxes. Such static rate files may have limited flexibility and accuracy. For example, a tax calculation performed using a static rate file may not reflect parameters of an individual transaction, current tax rules or regulations, or the particular business.

### SUMMARY

Aspects of the present disclosure provide systems, methods, apparatus, and computer-readable storage media that support local and cloud-based tax determination operations. In some examples, a transaction system may execute a local tax engine to enable localized tax calculation services in a lightweight footprint while still achieving one or more benefits of a cloud-based system (e.g., technical support and automatic updates of software and tax content). As a result, some aspects of the present disclosure may enable a “full power” tax engine that is local to (or included in) a transaction system while also enabling the tax engine to automatically sync back to a cloud-based system, such as to receive one or more of a configuration update, a software release, a software update, or updated tax content. Further, the transaction system may transmit results of tax calculations to the cloud-based system, such as for reporting, compliance, or both.

In some circumstances, by executing the local tax engine, a system may perform latency-sensitive operations (such as tax calculation) on-premises or near to the transaction system, which may enable the system to avoid network delays or latencies that may be associated with accessing a third party service for tax calculation. In addition, by performing synchronization and other operations using a cloud-based system, the system may achieve higher accuracy and reliability as compared to other techniques, such as use of a static rate file.

In one particular aspect, a method for local and cloud-based tax determination operations includes obtaining, at a transaction system, transaction data associated with one or more transactions. The method further includes executing, at the transaction system, a local tax engine based on the transaction data to generate tax data representing one or more tax values associated with the one or more transactions. The method further includes sending, by the transaction system, the tax data to a cloud-based tax management and reporting system that is remote to the transaction system. The method further includes receiving, at the transaction system, an entity level report from the cloud-based tax management and reporting system. The entity level report based at least in part on the tax data.

In another particular aspect, a system for local and cloud-based tax determination operations includes a memory and one or more processors communicatively coupled to the memory. The one or more processors are configured to obtain transaction data associated with one or more transactions and to execute a local tax engine based on the transaction data to generate tax data representing one or more tax values associated with the one or more transactions. The one or more processors are further configured to send the tax data to a cloud-based tax management and reporting system that is remote to the local tax engine and to keep the transaction data in a local store. The one or more processors are further configured to receive an entity level report from the cloud-based tax management and reporting system. The entity level report is based at least in part on the tax data.

In another particular aspect, a method for local and cloud-based tax determination operations includes receiving, at a cloud-based tax management and reporting system, tax data from a transaction system. The tax data is generated by a local tax engine associated with the transaction system based on transaction data associated with one or more transactions, and the tax data represents one or more tax values associated with the one or more transactions. The cloud-based tax management and reporting system is remote to the transaction system. The method further includes transmitting, by the cloud-based tax management and reporting system to the transaction system, an entity level report that is based at least in part on the tax data.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system that supports local and cloud-based tax determination operations according to one or more aspects;

FIG. 2 is a flow diagram illustrating some examples of functionality of the system of FIG. 1 according to one or more aspects;

FIG. 3 is a block diagram of an example of a system that supports local and cloud-based tax determination operations according to one or more aspects;

FIG. 4A is a block diagram of a portion of an example of a containerized system that supports local and cloud-based tax determination operations according to one or more aspects;

FIG. 4B is a block diagram of another portion of the containerized system of FIG. 4A according to one or more aspects;

FIG. 5 is a block diagram of an example of a containerized system that supports local and cloud-based tax determination operations according to one or more aspects;

FIG. 6 is a diagram illustrating examples of operations that support local and cloud-based tax determination operations according to one or more aspects;

FIG. 7 is a diagram illustrating examples of operations that support local and cloud-based tax determination operations according to one or more aspects;

FIG. 8 is a diagram illustrating examples of operations that support local and cloud-based tax determination operations according to one or more aspects;

FIG. 9 is a flow diagram illustrating an example of a method for local and cloud-based tax determination operations according to one or more aspects; and

FIG. 10 is a flow diagram illustrating an example of a method for local and cloud-based tax determination operations according to one or more aspects.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Various features and advantageous details are explained more fully with reference to the non-limiting aspects that are illustrated in the accompanying drawings and detailed in the following description. Descriptions of well-known starting materials, processing techniques, components, and equipment are omitted so as not to unnecessarily obscure the aspects of the disclosure in detail. It should be understood, however, that the detailed description and the specific examples, while indicating various implementations, are given by way of illustration only, and not by way of limitation. Various substitutions, modifications, additions, and/or rearrangements within the scope of the disclosure will become apparent to those skilled in the art from this disclosure.

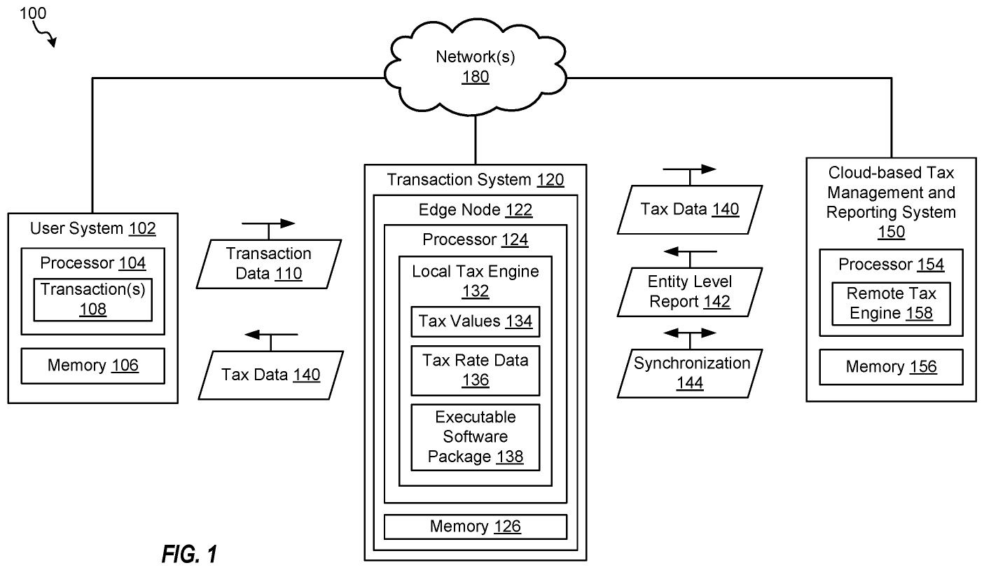

Referring to FIG. 1, an example of a system that supports local and cloud-based tax determination operations according to one or more aspects is shown as system 100. As shown in FIG. 1, system 100 may include user system 102, transaction system 120, and cloud-based tax management and reporting system 150. These components, and their individual components, may cooperatively operate to provide functionality in accordance with the discussion herein.

In some aspects, user system 102, transaction system 120, and cloud-based tax management and reporting system 150 may be communicatively coupled to one another via one or more networks 180. One or more networks 180 may include one or more of a wired network, a wireless communication network, a cellular network, a cable transmission system, a local area network (LAN), a wireless LAN (WLAN), a metropolitan area network (MAN), a wide area network (WAN), the Internet, the Public Switched Telephone Network (PSTN), or another network, as illustrative examples.

In some examples, the user system 102 may be coupled to transaction system 120 via a first network of the one or more networks 180, and transaction system 120 may be coupled to cloud-based tax management and reporting system 150 via a second network of the one or more networks 180. The first network may be associated with a first latency that is less than a second latency associated with the second network. To illustrate, in some examples, a physical distance between the user system 102 and transaction system 120 may be less than a second physical distance between transaction system 120 and cloud-based tax management and reporting system 150. Alternatively or in addition, the first network may include a first number of devices (such as nodes, switches, or hubs) that relay messages between the user system 102 and transaction system 120, and the second network may include a second number of devices (such as nodes, switches, or hubs) that relay messages between transaction system 120 and cloud-based tax management and reporting system 150. The first number of devices may be less than the second number of devices. In some other implementations, the user system 102 and transaction system 120 may be integrated within a single device (e.g., a single endpoint or edge server).

Alternatively or in addition, the transaction system 120 may be located in a different enterprise network as the cloud-based tax management and reporting system 150. For example, the transaction system 120 may be included in a first enterprise network, and the cloud-based tax management and reporting system 150 may be included in a second enterprise network that is different than the first enterprise network.

In some implementations, any of the user system 102, transaction system 120, or cloud-based tax management reporting system 150 may include or correspond to one or more servers. To illustrate, transaction system 120 may include an edge node 122 (e.g., an edge server). In some other examples, one or more devices illustrated in FIG. 1 may be implemented as another device. For example, in some implementations, user system 102 may include one or more of a mobile device, a smartphone, a tablet computing device, a personal computing device, a laptop computing device, a desktop computing device, a computer system of a vehicle, a personal digital assistant (PDA), a smart watch, another type of wired and/or wireless computing device, as illustrative examples.

Each device illustrated in FIG. 1 may include one or more processors and a memory. For example, the user system 102 may include a processor 104 and memory 106, edge node 122 may include processor 124 and memory 126, and cloud-based tax management and reporting system 150 may include processor 154 and memory 156.

In some aspects, one or more of the processors 104, 124, and 154 may include a processor, a microprocessor, a controller, a microcontroller, a plurality of microprocessors, an application-specific integrated circuit (ASIC), an application-specific standard product (ASSP), or any combination thereof, and may be configured to execute instructions to perform one or more operations described herein. In some aspects, implementations of one or more of the processors 104, 124, and 154 may include code segments (e.g., software, firmware, and/or hardware logic) executable to perform one or more tasks and functions described herein. In yet other aspects, one or more of the processors 104, 124, and 154 may be implemented as a combination of hardware and software. Processors 104, 124, and 154 may be communicatively coupled to memories 106, 126, and 156, respectively.

One or more of memories 106, 126, and 156 may include read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. Memories 106, 126, and 156 may store instructions that, when executed by the processors 104, 124, and 154, cause the processors 104, 124, and 154 to perform one or more operations described herein.

During operation, the transaction system 120 may execute a local tax engine 132 to initiate, perform, or control one or more operations described herein. In some examples, the edge node 122 executes the local tax engine 132 using the processor 124. The transaction system 120 may also execute one or more other applications or engines, such as one or more of an enterprise resource planning (ERP) application, customer relationship management (CRM) application, or eCommerce application, as illustrative examples.

To illustrate, the transaction system 120 may obtain transaction data 110 associated with one or more transactions 108. As an illustrative example, the one or more transactions 108 may include a sales transaction, such as a sale of a good or service. The transaction data 110 may indicate the sales transaction. For example, the transaction data 110 may indicate one or more of a timestamp associated with the sales transaction, an amount associated with the sales transaction, a currency (or virtual currency) associated with the sales transaction, a country, state, county, city, municipality, or other jurisdiction or region associated with the sales transaction, or a combination thereof, as illustrative examples. Alternatively or in addition, the one or more transactions 108 may include one or more other types of transactions, such as a lease or rental transaction.

To further illustrate, in some examples, the edge node 122 of the transaction system 120 may receive the transaction data 110 from the user system 102. In some such examples, the user system 102 may generate the transaction data 110 and may transmit the transaction data 110 to the edge node 122. To further illustrate, the user system 102 may include or may be coupled to a payment device, such as a credit card reader device that reads a credit card of a customer to determine payment information included in the transaction data 110. In some other examples, obtaining the transaction data 110 may include generating the transaction data 110 at the edge node 122. For example, instead of the customer providing the credit card to the payment device, the customer may input the payment information to the transaction system 120 (e.g., via a web browser or an application that communicates with the transaction system 120).

The transaction system 120 may execute the local tax engine 132 based on the transaction data 110 to generate tax data 140 representing one or more tax values associated with the one or more transactions 108. The one or more tax values may indicate an amount of tax (or an estimated amount of tax) associated with the one or more transactions 108. For example, the one or more tax values may include one or more of a federal tax, a state tax, a county tax, a city tax, or another tax associated with the one or more transactions 108. In some examples, a tax value indicated by the tax data 140 may be referred to as an indirect tax that is collected from a customer of the one or more transactions 108 by a merchant associated with the one or more transactions 108 and that is subsequently remitted by the merchant to a taxing authority.

In some examples, the local tax engine 132 may generate the tax data 140 based further on tax rate data 136 that is stored locally at the transaction system 120. For example, the tax rate data 136 may indicate federal tax rates, state tax rates, county tax rates, city tax rates, one or more other tax rates, or a combination thereof. Alternatively or in addition, the tax rate data 136 may include tax rates that are specific to a type of transaction associated with the one or more transactions 108, such as where a sale of one type of good or service is subject to a different tax rate (or no tax rate) as compared to a sale of another type of good or service (such as a sale of a food item as compared to the sale of a non-food item, or for a “green” energy transaction as compared to another type of energy transaction). Alternatively or in addition, the tax rate data 136 may include tax rates that are specific to one or more of a business associated with the user system 102 or a customer associated with the one or more transactions 108 (such as where a charity entity may be subject to different tax rates as compared to a non-charity entity). In some examples, the tax rate data 136 may include tax rates that are provided by the cloud-based management and reporting system 150 based on information provided by the transaction system 120, such as based on indication of a geographic location of the transaction system 120, based on an indication of an exempt or non-exempt status of a business, or the like.

In some implementations, the local tax engine 132 includes an executable software package 138 that includes one or more tax libraries, one or more entity-specific parameter libraries, one or more user credentials, or a combination thereof. The executable software package 138 may include one or more types of executable files, non-executable files, artifacts, scripts, libraries, other data, or a combination thereof, when installed on edge node 122, enable edge node 122 to perform tax determination, such as determination of the tax data 140. To illustrate, the executable software package 138 may include one or more operating systems (e.g., Linux-based or others), one or more scripting libraries (e.g., Python or the like), one or more other libraries, one or more configuration files, one or more other executable files or applications that enable data processing and communications between various clouds or devices, or a combination thereof. To further illustrate, the libraries, executable files, and applications may cause a device (such as the edge node 122) to receive the tax rate data 136 and to determine tax data (such as tax data 140) based on the tax rate data 136, to perform one or more other operations, or a combination thereof. The configuration files may denote where particular data is to be stored, access privileges associated with storage locations, features to be included in tax data, formatting, and the like. The communication files or applications may cause the device to communicate data to another device, such as in accordance with one or more formatting requirements, one or more application program interfaces (APIs), one or more cloud communication criteria, one or more command line interfaces (CLIs), or the like. In some implementations, the executable software package 138 may include or correspond to a container, such as a Kubemetes container (also referred to as “k8s”) or a Docker container, as illustrative examples. In other implementations, the executable software package 138 may include or correspond to another type of executable software package.

In some implementations, the transaction system 120 may provide the tax data 140 to the user system 102. For example, in some implementations in which the edge node 122 receives the transaction data 110 from the user system 102, the edge node 122 may transmit the tax data 140 to the user system 102 to enable the user system 102 to collect one or more taxes indicated by the tax data 140.

Alternatively or in addition, the transaction system 120 may send the tax data 140 to the cloud-based management and reporting system 150. The cloud-based management and reporting system 150 may receive the tax data 140 and may perform one or more operations based on the tax data 140. In some examples, the cloud-based management and reporting system 150 may store the tax data 140 to a tax database. For example, the tax database may indicate taxes determined by the transaction system 120.

In some examples, one or both of the transaction data 110 or the tax data 140 generated from the local tax engine 132 may not be transmitted back to the cloud-based tax management and reporting system 150. In some examples, the transaction system 120 may keep the transaction data 110 in a local network associated with the transaction system 120 (e.g., for compliance with data residency requirements or regulations). In some examples, the transaction system 120 may keep (e.g., store) the transaction data 110 in a local store of the transaction system 120 (e.g., in the memory 126) without providing any of, or a portion thereof, the transaction data 110 to the cloud-based tax management and reporting system 150. Additionally or alternatively, the tax data 140, or a portion thereof, may be similarly kept in the local store of the transaction system 120 in accordance with one or more data residency requirements or regulations.

The cloud-based management and reporting system 150 may generate an entity level report 142 and may transmit the entity level report 142 to the transaction system 120. The entity level report 142 may be based at least in part on the tax data 140. To illustrate, the cloud-based management and reporting system 150 may periodically generate the entity level report 142, such as by generating the entity level report 142 on a weekly, biweekly, monthly, quarterly, annual, or other basis.

In some examples, the entity level report 142 may be specific to a particular tax authority. For example, in some implementations, the entity level report 142 may be specific to federal taxes, state taxes, county taxes, city taxes, or other taxes. In some examples, the entity level report 142 may be specific to a client or a customer. Further, the entity level report 142 may be updated in real-time or near-real-time. In some implementations, the entity level report 142 may indicate, based on an amount of tax data generated by the transaction system 120 (including the tax data 140), an estimated tax liability for a particular time frame, such as for a quarter, calendar year, or fiscal year.

In some examples, the cloud-based management and reporting system 150 may customize or “tailor” the entity level report 142 based on one or more parameters associated with a business associated with the transaction system 120. For example, the cloud-based management and reporting system 150 may generate the entity level report 142 based on a geographic location associated with the business, such as a place of incorporation of the business or one or more points-of-sale associated with the business, which may affect taxation associated with the business. Alternatively or in addition, the entity level report 142 may be based on types of transactions associated with the business, such as sales of food or non-food items, or green energy or other energy transactions, which may affect taxation associated with the business.

In some implementations, the cloud-based management and reporting system 150 may include a remote tax engine 158. The transaction system 120 and the cloud-based management and reporting system 150 may perform a synchronization 144 of the local tax engine 132 and the remote tax engine 158. For example, performing the synchronization 144 may include one or more of transmitting, from the transaction system 120 to the cloud-based tax management and reporting system 150, a request for a configuration update or receiving, at the transaction system 120 from the cloud-based tax management and reporting system 150, the configuration update. Alternatively or in addition, performing the synchronization 144 may include receiving, at the transaction system 120 from the cloud-based tax management and reporting system 150, updated tax content. Alternatively or in addition, performing the synchronization 144 may include transmitting, from the transaction system 120 to the cloud-based tax management and reporting system 150, one or more of compliance data or tax reporting data.

In some examples, the synchronization 144 is performed at a time that is selected to reduce or avoid a network delay or latency. For example, the synchronization 144 may be scheduled to occur at an “off-peak” network time when the one or more networks 180 may experience a relatively light amount of traffic.

In some examples, the cloud-based management and reporting system 150 may initiate an update of the tax rate data 136 (e.g., in connection with the synchronization 144). For example, the cloud-based management and reporting system 150 may receive a notification of a change in one or more tax rates. In response to the notification, the cloud-based management and reporting system 150 may push the update to the transaction system 120 to modify the tax rate data 136 based on the change in the one or more tax rates. By pushing such updates to one or more transaction systems (such as the transaction system 120), the cloud-based management and reporting system 150 may provide efficient monitoring and updating of tax rates for one or more transaction systems (such as the transaction system 120).

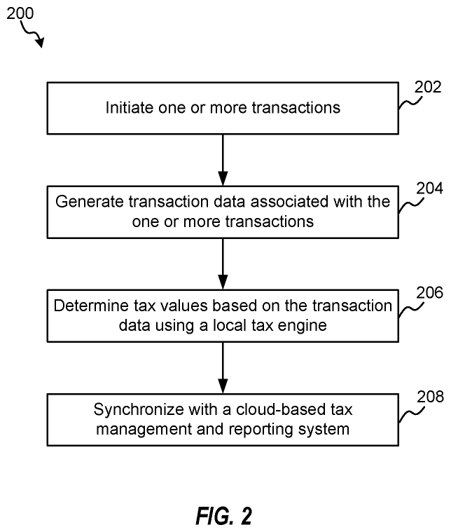

FIG. 2 shows a flow diagram illustrating some examples of functionality of system 100 for performing local and cloud-based tax determination operations. Blocks of method 200 illustrated in FIG. 2 may be performed by one or more components of system 100 of FIG. 1.

At block 202, the method 200 may include initiating one or more transactions. For example, user system 102 may perform or initiate the one or more transactions 108.

At block 204, the method 200 may include generating transaction data associated with the one or more transactions. For example, user system 102 may generate transaction data 110 associated with the one or more transactions 108 and may provide transaction data 110 to transaction system 120.

At block 206, the method 200 may include determining tax values based on the transaction data using a local tax engine. For example, the transaction system 120 may execute the local tax engine 132 to determine tax values 134 based on the transaction data 110.

At block 208, the method 200 may include synchronizing with a cloud-based tax management and reporting system. For example, the transaction system 120 and the cloud-based tax management and reporting system 150 may perform the synchronization 144.

One or more aspects described herein may improve perform of a system, such as the system 100 of FIG. 1. For example, the transaction system 120 may execute the local tax engine 132 to enable localized tax calculation services in a lightweight footprint while still achieving one or more benefits of a cloud-based system via the cloud-based tax management and reporting system 150 (e.g., technical support and automatic updates of software and tax content, which may be performed via synchronization 144). As a result, the transaction system 120 may achieve one or more benefits of a “full power” tax engine that is local to (or included in) the transactional system 120, such as at an edge device (or even an endpoint device, in some implementations) while also enabling the local tax engine 132 to automatically sync back to the cloud-based tax management and reporting system 150. In some examples, by executing the local tax engine 132, the transaction system 120 may perform latency-sensitive operations (such as tax calculation) on-premises or near to the transaction system 120, which may enable the transaction system 120 to avoid network delays or latencies that may be associated with accessing a third party service for tax calculation. In addition, by performing synchronization and other operations using the cloud-based tax management and reporting system 150, the transaction system 120 may achieve higher accuracy and reliability as compared to other techniques, such as use of a static rate file.

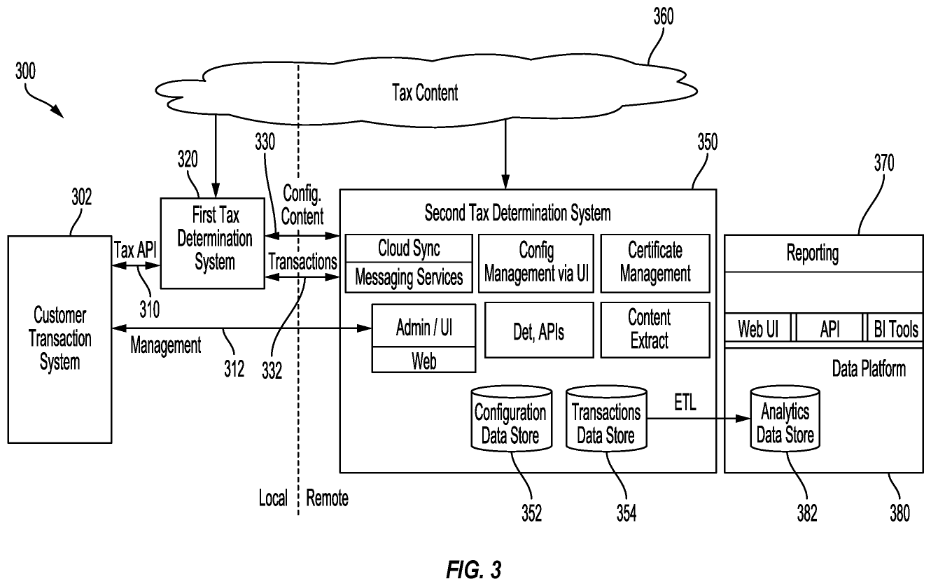

Referring to FIG. 3, an example of a system that supports local and cloud-based tax determination operations according to one or more aspects is shown as system 300. The system 300 may include a customer transaction system 302, a first tax determination system 320, a second tax determination system 350, and a data platform 380. The customer transaction system 302 may be coupled to the first tax determination system 320 and to the second tax determination system 350. The second tax determination system 350 may be coupled to the data platform 380.

In some examples, one or more features of FIG. 3 may correspond to one or more features of FIG. 1. For example, the customer transaction system 302 may include or correspond to the user system 102 of FIG. 1. As another example, the first tax determination system 320 may include or correspond to the transaction system 120 of FIG. 1. As an additional example, the second tax determination system 350 may include or correspond to the cloud-based management and reporting system 150 of FIG. 1.

In some implementations, the first tax determination system 320 may be located at a common location as the customer transaction system 302. The common location may correspond to a place of business or point-of-sale (e.g., where the first tax determination system 320 is co-located on-premises with the customer transaction system 302). In some other implementations, the common location may be remote to the place of business or point-of-sale, such as if the customer transaction system 302 and the first tax determination system 320 are hosted at a cloud provider site. Further, the second tax determination system 350 and the data platform 380 may be remote to the customer transaction system 302 and the first tax determination system 320.

During operation, the system 300 may perform one or more operations described herein. For example, the first tax determination system 320 may determine the tax data 140 based on the transaction data 110 and may provide the tax data 140 to one or more of the customer transaction system 302 or the second tax determination system 350.

In some examples, one or both of the first tax determination system 320 or the second tax determination system 350 may receive tax content 360. In some examples, the tax content 360 may include or correspond to the tax rate data 136 of FIG. 1.

The customer transaction system 302 may communicate with the first tax determination system 320 using one or more interfaces or links. For example, the customer transaction system 302 may communicate with the first tax determination system 320 using one or more of a tax application program interface (API) 310 or a management interface 312.

In some implementations, operation of the first tax determination system 320 may be based on or may conform to one or more policies associated with the customer transaction system 302. For example, operation of the first tax determination system 320 may be based on or may conform to one or more of a disaster recovery policy, an availability policy, a fault-tolerance policy, a security policy, a monitoring policy, a logging policy, or a deployment policy (e.g., by being compatible with both cloud-based or on-premises deployment) associated with the customer transaction system 302.

The first tax determination system 320 may communicate configuration content 330 with the second tax determination system 350. The first tax determination system 320 may perform transactions 332 with the second tax determination system 350.

The second tax determination system 350 may perform operations including a cloud sync operation (e.g., the synchronization 144 of FIG. 1), configuration management via a user interface (UI), certificate management, administration or UI administration, API management, or content extraction, one or more other operations, or a combination thereof. To further illustrate, the second tax determination system 350 may perform the cloud sync operation using one or more messaging services and may perform the administration or UI administration using a web interface.

The second tax determination system 350 may include a configuration data store 352 and a transactions data store 354. To illustrate, the configuration data store 352 may include configuration data associated with the transaction system 120 of FIG. 1, and the transactions data store 354 may include the transaction data 110 of FIG. 1. In some examples, the second tax determination system 350 may provide transactions data (e.g., the transaction data 110 of FIG. 1) from the transactions data store 354 to the data platform 380. For example, the second tax determination system 350 may provide the transactions data from the transactions data store 354 to an analytics data store 382 of the data platform 380, such as via an extract, transform, and load (ETL) data integration process.

The data platform 380 may perform one or more data analytics operations based on analytics data of the analytics data store 382. For example, the data platform 380 may perform data analytics based on the transaction data 110 of FIG. 1. The one or more data analytics operations may include analyzing an aggregate amount of taxes collected, analyzing a per-location or per-customer amount of taxes collected, forecasting additional taxes to be collected during a time period, predicting compliance with one or more regulations or criteria, or the like.

In some examples, the data platform 380 may perform reporting 370. For example, the data platform 380 may generate (e.g., based on analytics data of the analytics data store 382) tax reporting data associated with the customer transaction system 302. For example, performing the reporting 370 may include generating the entity level report 142 of FIG. 1. The reporting 370 may include results of any of the one or more data analytics operations performed based on the analytics data of the analytics data store 382. The data platform 380 may perform the reporting 370 based on one or more of a web UI, an API, or a business intelligence (BI) tool, as illustrative examples.

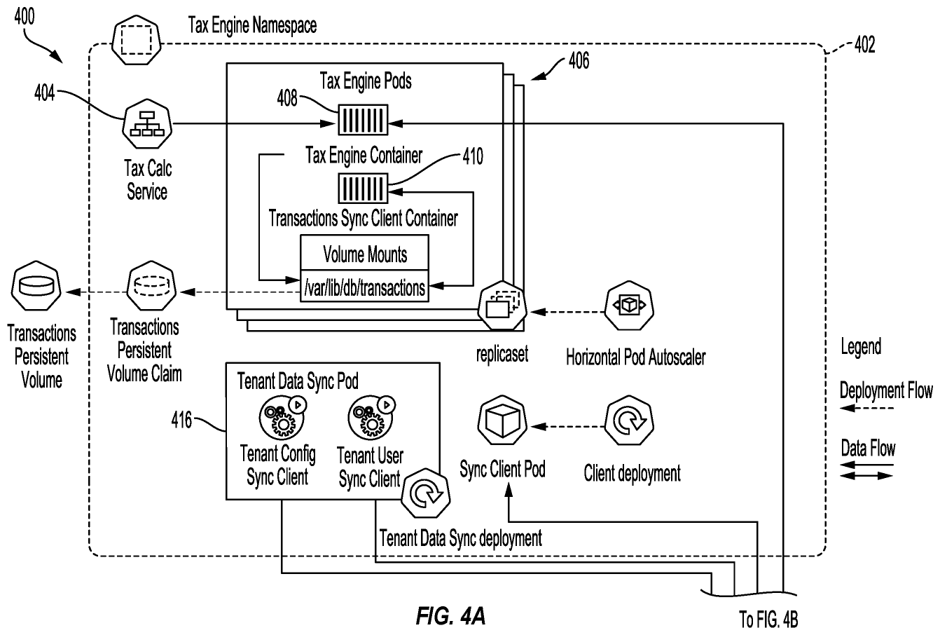

Referring to FIGS. 4A and 4B, an example of a containerized system that supports local and cloud-based tax determination operations according to one or more aspects is shown as containerized system 400. In some implementations, a container infrastructure may enable operations of the containerized system 400. In some examples, the container infrastructure may correspond to an open source container infrastructure, such as a Kubernetes container infrastructure or a Docker container infrastructure, as illustrative examples. In some aspects, the container infrastructure may enable a standardized, declarative way to define, provision, and manage virtualized resources and software, particularly for supporting a local tax engine and/or a remote tax engine.

The containerized system 400 may include or may operate based on a tax engine namespace 402 and a database namespace 452. In some aspects, the tax engine namespace 402 may be included in or associated with the transaction system 120 of FIG. 1, and database namespace 452 may be included in or associated with the cloud-based tax management and reporting system 150 of FIG. 1.

The tax engine namespace 402 may be associated with tax engine pods 406 and a tenant data sync pod 416. The tax engine pods 406 may include a tax engine container 408 and a transaction sync client container 410. The tax engine namespace 402 may enable one or more operations described herein, such as a tax calculation service 404, as illustrated. In some examples, performing the tax calculation service 404 includes determining the tax data 140 of FIG. 1.

In some examples, “tenant” may refer to an operator (e.g., a company or other entity) associated with a transaction system, such as the transaction system 120 of FIG. 1, the customer transaction system 302 of FIG. 3, or a combination thereof. The tax engine namespace 402 may service or may be associated with multiple tenants. A tenant pod may include components that perform tax calculation operations, synchronization operations (such as operations of the synchronization 144 of FIG. 1), other operations, or a combination thereof. For example, a tenant pod of FIG. 4A (such as a particular tax engine pod of the tax engine pods 406) may download and locally apply customized tax and configuration data corresponding to a particular tenant (which may include the tax rate data 136 of FIG. 1, the tax content 360 of FIG. 3, or a combination thereof). As another example, a tenant pod of FIG. 4A (such as the tenant data sync pod 416) may operate user accounts to authorize tax calculation requests (such as a tax calculation request included in or associated with the transaction data 110 of FIG. 1, which may be received via the tax API 310 of FIG. 3).

The database namespace 452 may be associated with database pods 456, which may include a database container 460. The database namespace 452 may enable one or more operations described herein, such as a database read and write (R/W) service 464, as illustrated. In some examples, the database described with reference to FIGS. 4A and 4B may correspond to a PostgreSQL database or another database.

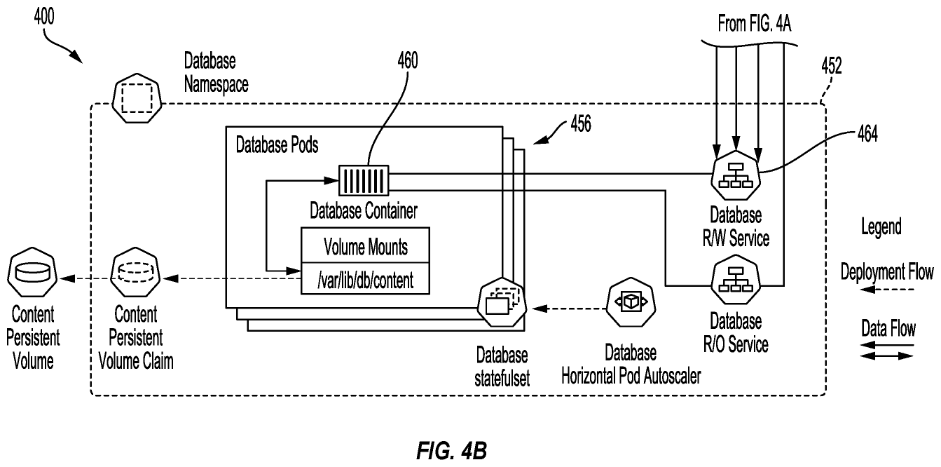

During operation, the containerized system 400 may perform one or more operations, such as synchronization operations. For example, the tenant data sync pod 416 may initiate, perform, or control one or more operations of synchronization 144 of FIG. 1, which may include writing data to database namespace 452 (e.g., via the database R/W service 464). Certain examples of synchronization operations in a containerized environment are described further with reference to FIG. 5.

Referring to FIG. 5, an example of a containerized system that supports local and cloud-based tax determination operations according to one or more aspects is shown as system 500. The containerized system 500 may include a customer transaction system 502 (e.g., the transaction system 120, the customer transaction system 302, or a combination thereof) and a container orchestration 520. Although the container orchestration 520 is illustrated as being external to the customer transaction system 502, in some examples, one or more features of the container orchestration 520 may be included in the customer transaction system 502.

The containerized system 500 may further include a cloud sync server 550 and a technical support center 590. The cloud sync server 550 and the technical support center 590 may be remote to the customer transaction system 502 and to the container orchestration 520. For example, the customer transaction system 502 and the container orchestration 520 may be included in a first enterprise network that is different than a second enterprise network that includes the cloud sync server 550 and the technical support center 590.

In some examples, the transaction system 120 of FIG. 1 may include, may be associated with, or may operate based on the container orchestration 520. The cloud-based tax management and reporting system 150 may include or correspond to the cloud sync server 550. Container orchestration 520 may include or execute a local tax calculation service 522, a database service 530, persistent volumes 536, and content synchronization service 544.

During operation, the containerized system 500 may perform synchronization with a cloud synchronization service hosted by the cloud sync server 550. In some examples, the cloud synchronization service is enabled using a Java-based framework, such as a Spring Boot Java-based framework.

The cloud sync server 550 may perform data synchronization with one or more remote deployments of tax engine 524. The data synchronization may include tax calculation transactions. For example, the tax engine pods 406 may accumulate transactions (such as the tax data 140) that may result from serving tax calculation requests, such as one or more requests from the user system 102 of FIG. 1. The tax engine 524 of FIG. 5 may periodically offload the accumulated transactions (such as the tax data 140) to the cloud sync server 550 (indicated in FIG. 5 via transaction sync client 526). The tax engine 524 may initiate a write operation to write the accumulated transactions to the database pods 456 (e.g., via the database R/W service 464).

In some examples, a customer may initiate a change associated with the containerized system 500. If the customer is associated with multiple copies of the tax engine 524 (e.g., if the customer has purchased multiple licenses to the tax engine 524), the change initiated by the customer may be propagated to each instance of the tax engine 524 associated with the customer. For example, a customer may utilize a cloud determination user interface (UI) to change a tenant configuration (config), which may be propagated by the tenant data sync pod 416 to each instance of the tax engine 524 associated with the customer (indicated in FIG. 5 via tenant config sync client 546).

In some examples, the cloud sync server 550 may include one or more tax calculation API endpoints. To access a tax calculation API endpoint, the customer may utilize one or more credentials. The one or more credentials may be managed by the cloud sync server and may be synchronized with the tax engine 524 (e.g., via tenant user sync client 548). In some examples, the tax engine 524 may present the one or more credentials to enable one or more communications with the cloud sync server 550, such as to enable one or more of transmitting the tax data 140, receiving the entity level report 142, or performing the synchronization 144 of FIG. 1.

In some examples, the cloud sync server 550 may expose one or more representational state transfer (REST) endpoints to enable one or more operations described herein. For example, the cloud sync server 550 may expose one or more REST endpoints 552 to the container orchestration 520 to enable operations by one or more of the transaction sync client 526, the tenant config sync client 546, or the tenant user sync client 548. In some implementations, such sub-systems may operate in standalone Java-based applications (such as Spring Boot Java-based applications), which may facilitate parallel development, testing, and debugging as well as packaging into a composite associated with cloud sync server 550.

To further illustrate, in some implementations, transaction sync client 526 may run as a sidecar container along with tax engine 524. Tax engine 524 may serve tax calculation requests and may produce serialized representations of invoice documents, which may be stored on a local filesystem that may be mounted on a containerized persistent volume of persistent volumes 536. An example of a serialized invoice object may be a serialized JavaScript Object Notation (JSON) object that represents one or more invoices. The transaction sync client 526 may receive the serialized invoice objects from the tax engine 524 and may push the serialized invoice objects to the cloud sync server 550 via invoice sync service endpoint 554. Invoice sync service endpoint 554 may be exposed by transactions sync service 564 of cloud sync server 550.

Tenant config sync client 546 may import customer tenant configuration changes (which may include tenant companies and child companies) from the cloud sync server 550 to the container orchestration 520. The tenant config sync client 546 may communicate with config sync service endpoint 556, which may be exposed by tenant config sync service 566 of cloud sync server 550.

Tenant user sync client 548 may synchronize tenant users, which may be managed via a cloud infrastructure. To illustrate, tenant user sync client 548 may receive a user synchronization from cloud sync server 550. Tenant user sync client 548 may communicate with user sync service endpoint 558, which may be exposed by tenant user sync service 568 of the cloud sync server 550.

To further illustrate some aspects, cloud sync server 550 may use one or more security practices with respect to authentication and authorization of devices and requests from devices. For example, a “cloud sync user role” may be used to support data synchronization or data synchronization interfaces. A customer or user may be issued a unique service “native” user account, under a respective tenant, which may be granted a cloud sync user role and a permission to perform export or import activities. An endpoint (such as one or more of the endpoints 554, 556, and 558) may be subject to authentication and authorization procedures and may also ensure that an authenticated user is authorized under a cloud sync user role. In some implementations, a “basic” authorization scheme may be used with one or more endpoints (such as one or more of the endpoints 554, 556, and 558). For example, the one or more endpoints may perform communications using an encrypted transport technique, such as transport layer security version two (TLSv2). In other implementations, a different authorization scheme may be used.

In some aspects, one or more devices or device components described herein may provide reports (which may indicate status, progress, and outcome) associated with one or more operations performed by the one or more devices or device components. The reports may increase logging, monitoring, traceability, reporting, and may aid in support activities. To illustrate, the reports may indicate one or more of an activity identifier (ID), an event timestamp, an activity boundary, a tenant ID, or an operation outcome. In some examples, the activity ID may include a universal unique identifier (UUID). The activity ID may be assigned to an operation at a time of inception of the operation. An event related to progress of the operation may carry the activity ID, which may enable an operation history to be traced via the activity ID. The event timestamp may be provided via an underlying logging facility. The activity boundary may indicate one or more of a start or end associated with the operation. The tenant ID may indicate one or more of a name or other identification, such as an external ID or other ID. The activity outcome may indicate one of a successful completion of the operation, a partial success of the operation (e.g., where the operation has partially succeeded and partially failed), or a failure of the operation. The activity outcome may indicate a reason for the successful completion, partial success (e.g., by indicating which portion of the operation succeeded or failed), or failure (e.g., to aid in support and mitigation processes).

The technical support center 590 may receive and respond to requests for support from one or more devices, such as customer transaction system 502 or container orchestration 520. To illustrate, upon encountering a technical issue with local tax calculation service 522 or tax engine 524, customer transaction system 502 may initiate a support request to the technical support center 590 (e.g., via “standard” content sync client 549). The support request may indicate information associated with the technical issue, such as a trouble code or a description of the technical issue. The technical support center 590 may process the support request and may provide technical support to customer transaction system 502. In some examples, the technical support center 590 use data analytics (such as using the analytics data store 382 of FIG. 3) to provide technical support. For example, the technical support center 590 may monitor technical issues experienced by multiple deployments of the tax engine 524 and may perform data analytics based on the technical issues to identify a common cause of the technical issues in some cases.

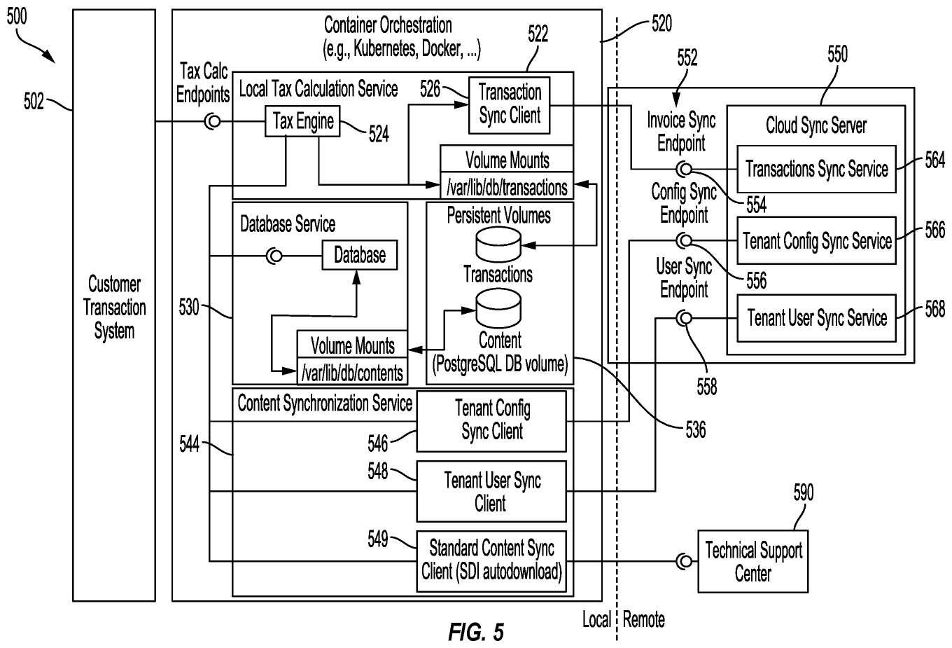

Referring to FIG. 6, examples of operations that support local and cloud-based tax determination operations according to one or more aspects are shown as operations 600. In some examples, the operations 600 may be performed by a customer system 601 (e.g., the user system 102), a tax engine 602 (e.g., the local tax engine 132, the tax engine 524, or a combination thereof), a file system 604, a transaction sync client 606 (e.g., the transaction sync client 526), and a transaction sync service 608 (e.g., the transaction sync service 564).

The operations 600 may include generating an invoice, at 620. For example, the customer system 601 may provide the invoice to the tax engine 602. The tax engine 602 may store the invoice, at 622, to the file system 604. The transaction sync client 606 may scan the invoices, at 626, from the file system 604 (e.g., based on performing a sync operation, at 624).

For each invoice stored at the file system 604, the transaction sync client 606 may provide, at 628, the invoice to the transaction sync service 608 and may receive, at 630, a result of providing the invoice to the transaction sync service 608. Based on the result indicating success, the transaction sync client 606 may remove the invoice, at 632, from the file system 604.

To further illustrate, in some examples, transaction sync client 606 may receive audit invoices, stored in a configured directory location of file system 604 (e.g., a local file system), to the cloud server 550 of FIG. 5 via the invoice sync service endpoint 554 of FIG. 5, which may be exposed to authorized “native” users (e.g., members of a “cloud sync user” role) by an application of cloud sync server 550 (e.g., a member of a cloud determination applications suite). The outbound invoice files may include JSON serialized invoice objects, which may be produced by the tax engine 524 based on servicing of tax calculation requests. Successfully synchronized invoice files may then be removed from the filesystem 604 to reclaim storage space. One or more success criteria for successful synchronization may be determined based on a response received from a call to transaction sync service 608. For example, the response may indicate a particular code, such as a hypertext transfer protocol (HTTP) status code of “200,” which may indicate that the invoice has been successfully stored to a cloud database. Any other response may be considered an error, which may cause the invoice object file to remain on the filesystem 604 for a subsequent reattempt at synchronization (e.g., instead of removing the invoice, at 632). Once synchronized, data may be sent to a reporting application (e.g., for reporting 370 of FIG. 3), which may be performed via an ETL process, thus making the data available for analysis and compliance purposes.

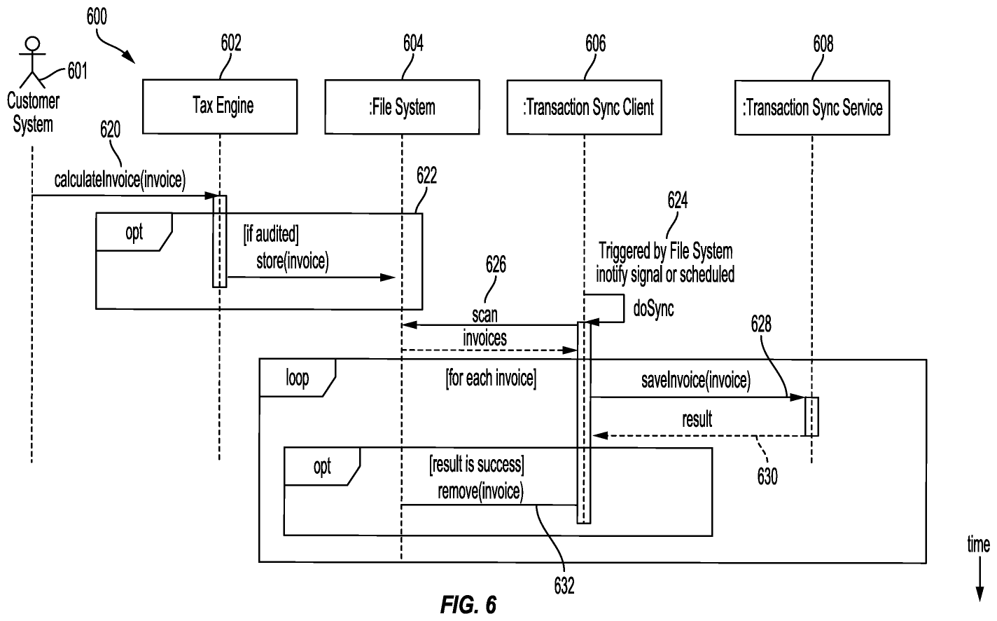

Referring to FIG. 7, examples of operations that support local and cloud-based tax determination operations according to one or more aspects are shown as operations 700. In some examples, the operations 700 may be performed by a tenant config sync scheduler 701, a tenant config sync client 702 (e.g., the tenant config sync client 546), an importing service 704, and a tenant config sync service 706 (e.g., the tenant config sync service 566).

The operations 700 may include initiating a sync via a sync trigger event, at 720. For example, the tenant config sync scheduler 701 may notify the tenant config sync client 702 to perform a synchronization operation, which may include or correspond to one or more operations of the synchronization 144 of FIG. 1.

The operations 700 may further include transmitting a request to receive a tenant configuration, at 722. For example, the tenant config sync client 702 may transmit the request to the tenant config sync service 706 (e.g., via the config sync service endpoint 556 of FIG. 5).

The operations 700 may further include receiving a response to the request, at 724. For example, the tenant config sync client 702 may receive the tenant configuration from the tenant config sync service 706. To further illustrate, based on successfully processing the request, the tenant config sync service 706 may transmit the response (e.g., an “application/octet stream” content type response) with a resulting export file attachment indicating a status code, such as HTTP status code “200”. In other cases, the tenant config sync service 706 may transmit a message indicating an error status (e.g., an HTTP error status code), which may be supplemented by a text description of the error status.

The operations 700 may further include, based on successfully receiving the tenant configuration, performing an import operation, at 726. For example, the tenant config sync client 702 may transmit the tenant configuration to the importing service 704.

To further illustrate, in some implementations, one or more messages described with reference to FIG. 7 may not include an explicit argument identifying the tenant configuration requested. For example, the tenant config sync service 706 may extract or infer an identity of the tenant config sync client 702 based on security context data (e.g., one or more credentials) included in the request transmitted at 722. The security context data may indicate that the tenant config sync client 702 corresponds to an authorized user of the tenant config sync service 706. In some examples, the security context data indicates that the authorized user carries associated tenant and roles information.

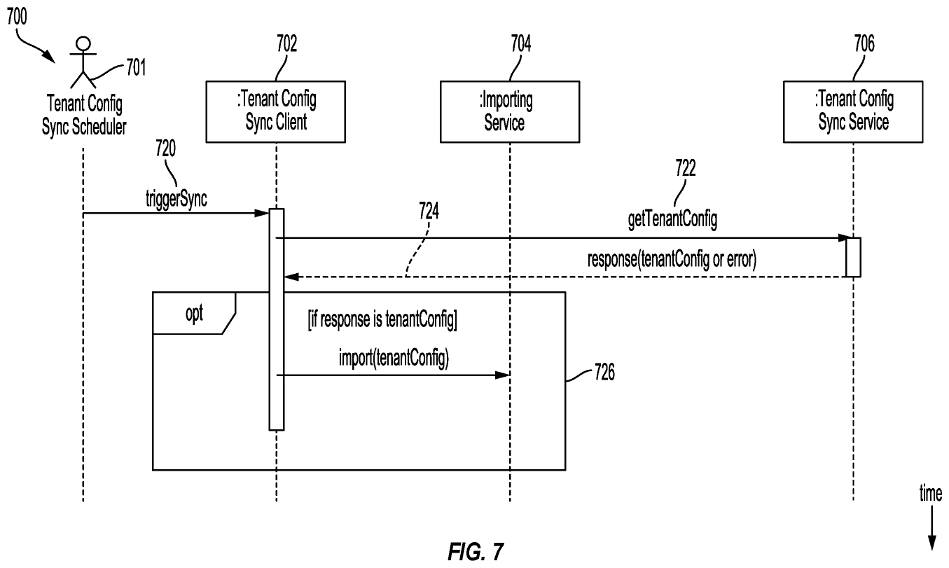

Referring to FIG. 8, examples of operations that support local and cloud-based tax determination operations according to one or more aspects are shown as operations 800. In some examples, the operations 800 may be performed by a tenant user sync scheduler 801, a tenant user sync client 802 (e.g., the tenant user sync client 548), an importing service 804 (e.g., the importing service 804), and a tenant user sync service 806 (e.g., the tenant user sync service 568).

The operations 800 may include initiating a sync via a sync trigger event, at 820. For example, the tenant user sync scheduler 801 may notify the tenant user sync client 802 to perform a synchronization operation, which may include or correspond to one or more operations of the synchronization 144 of FIG. 1.

The operations 800 may further include transmitting a request to receive user data, at 822. For example, the tenant user sync client 802 may transmit the request to the tenant user sync service 806 (e.g., via the user sync service endpoint 558 of FIG. 5).

The operations 800 may further include receiving a response to the request, at 824. For example, the tenant user sync client 802 may receive the user data from the tenant user sync service 806. To further illustrate, based on successfully processing the request, the tenant user sync service 806 may transmit the response (e.g., an “application/octet stream” content type response) with a resulting export file attachment indicating a status code, such as HTTP status code “200”. In other cases, the tenant user sync service 806 may transmit a message indicating an error status (e.g., an HTTP error status code), which may be supplemented by a text description of the error status.

The operations 800 may further include, based on successfully receiving the user data, performing an import operation, at 826. For example, the tenant user sync client 802 may transmit the user data to the importing service 804.

To further illustrate, in some implementations, one or more messages described with reference to FIG. 8 may not include an explicit argument identifying the user data requested. For example, the tenant user sync service 806 may extract or infer an identity of the tenant user sync client 802 based on security context data (e.g., one or more credentials) included in the request transmitted at 822. The security context data may indicate that the tenant user sync client 802 corresponds to an authorized user of the tenant user sync service 806. In some examples, the security context data indicates that the authorized user carries associated tenant and roles information.

Accordingly, the tenant user sync service 806 may serve authorized requests (such as the request transmitted at 822) from tenant user sync client 802. The tenant user sync service 806 may fulfill such requests by exporting user and role information (such as by transmitting the user data at 824) from a cloud-based system (such as cloud sync server 550 of FIG. 5) that is associated with a tenant and under which an authorized user operates. The authorized user may possess one or more credentials (such as a “cloud sync user” role credential) in order to perform such operations (e.g., in order to successfully request and receive the user data transmitted at 824).

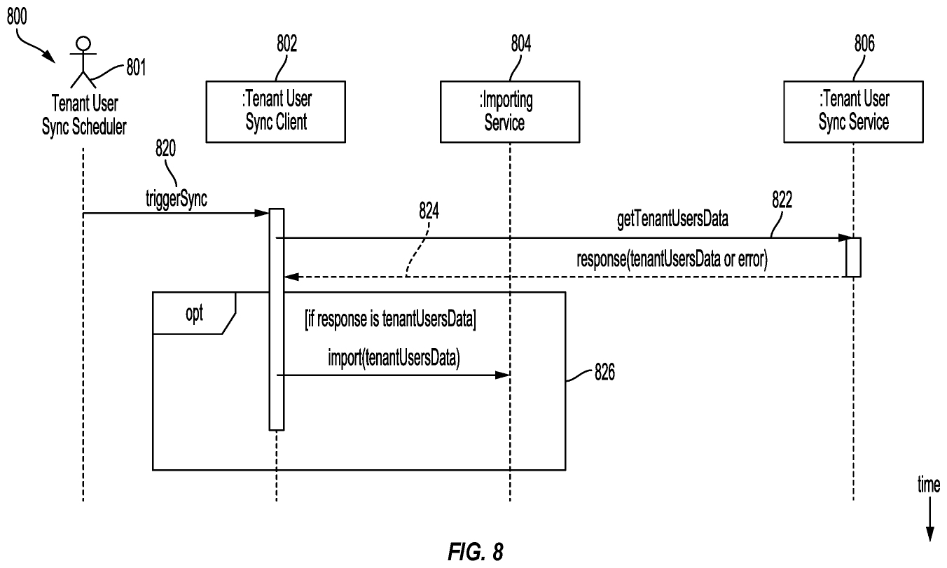

FIG. 9 is a flow diagram of a method 900 for local and cloud-based tax determination operations according to one or more aspects. In some implementations, the operations of method 900 may be stored as instructions that, when executed by one or more processors (e.g., the one or more processors of a computing device or a server), cause the one or more processors to perform the operations of method 900. In some implementations, method 900 may be performed by system 100 of FIG. 1 (e.g., by transaction system 120 or by edge node 122), one or more components to execute the operations described with reference to FIG. 2, system 300 of FIG. 3, containerized system 400 of FIGS. 4A and 4B, containerized system 500 of FIG. 5, one or more components to execute the operations 600 of FIG. 6, one or more components to execute the operations 700 of FIG. 7, or one or more components to execute the operations 800 of FIG. 8.

Method 900 includes obtaining, at a transaction system, transaction data associated with one or more transactions, at 902. For example, transaction system 120 may obtain transaction data 110 (e.g., by receiving transaction data 110 from user system 102 or by generating transaction data 110) associated with the one or more transactions 108.

Method 900 further includes executing, at the transaction system, a local tax engine based on the transaction data to generate tax data representing one or more tax values associated with the one or more transactions, at 904. For example, transaction system 120 may execute local tax engine 132 to generate tax data 140 representing the tax values 134 associated with the one or more transactions 108.

Method 900 further includes sending, by the transaction system, the tax data to a cloud-based tax management and reporting system that is remote to the transaction system, at 906. For example, the transaction system 120 may send the tax data 140 to the cloud-based tax management and reporting system 150.

Method 900 further includes receiving, at the transaction system, an entity level report from the cloud-based tax management and reporting system, at 908. The entity level report is based at least in part on the tax data. For example, transaction system 120 may receive, from cloud-based tax management and reporting system 150, the entity level report 142 based at least in part on the tax data 140.

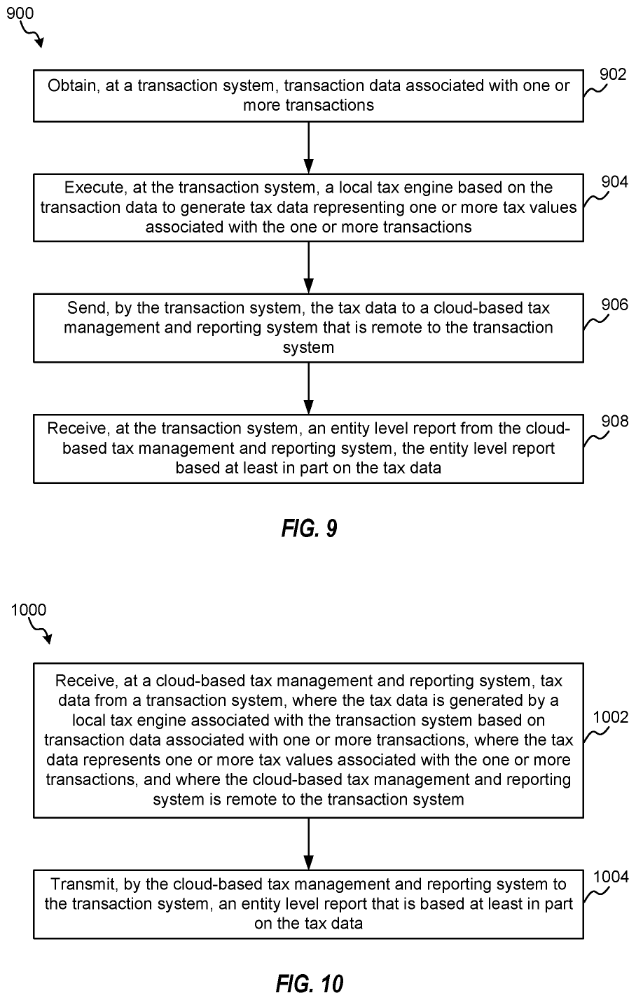

FIG. 10 is a flow diagram of a method 1000 for local and cloud-based tax determination operations according to one or more aspects. In some implementations, the operations of method 1000 may be stored as instructions that, when executed by one or more processors (e.g., the one or more processors of a computing device or a server), cause the one or more processors to perform the operations of method 1000. In some implementations, method 1000 may be performed by system 100 of FIG. 1 (e.g., by cloud-based tax management and reporting system 150), one or more components to execute the operations described with reference to FIG. 2, system 300 of FIG. 3, containerized system 400 of FIGS. 4A and 4B, containerized system 500 of FIG. 5, one or more components to execute the operations 600 of FIG. 6, one or more components to execute the operations 700 of FIG. 7, or one or more components to execute the operations 800 of FIG. 8.

Method 1000 further includes receiving, at a cloud-based tax management and reporting system, tax data from a transaction system that is remote to the transaction system, at 1002. The tax data is generated by a local tax engine associated with the transaction system based on transaction data associated with one or more transactions, and the tax data represents one or more tax values associated with the one or more transactions. The cloud-based tax management and reporting system is remote to the transaction system. For example, the cloud-based tax management and reporting system 150 may receive the tax data 140 from the transaction system 120. The tax data 140 may be based on the transaction data 110 associated with the one or more transactions 108.

Method 1000 further includes transmitting, by the cloud-based tax management and reporting system to the transaction system, an entity level report that is based at least in part on the tax data, at 1004. For example, the cloud-based tax management and reporting system may transmit the entity level report 142 to the transaction system 120 based at least in part on the tax data 140.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

Functional blocks and modules in FIGS. 1-7 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for local and cloud-based tax determination operations, the method comprising:
obtaining, at a transaction system, transaction data associated with one or more transactions;
executing, at the transaction system, a local tax engine based on the transaction data to generate tax data representing one or more tax values associated with the one or more transactions;
sending, by the transaction system, the tax data to a cloud-based tax management and reporting system that is remote to the transaction system; and
receiving, at the transaction system, an entity level report from the cloud-based tax management and reporting system, the entity level report based at least in part on the tax data.

2. The method of claim 1, wherein the local tax engine generates the tax data based further on tax rate data that is stored locally at the transaction system.

3. The method of claim 2, further comprising automatically receiving an update of the tax rate data from the cloud-based tax management and reporting system.

4. The method of claim 1, wherein the cloud-based tax management and reporting system includes a remote tax engine that is remote to the local tax engine, and further comprising performing, by the transaction system, synchronization of the local tax engine with the remote tax engine.

5. The method of claim 4, wherein performing the synchronization includes one or more of:
transmitting, from the transaction system to the cloud-based tax management and reporting system, a request for a configuration update;
receiving, at the transaction system from the cloud-based tax management and reporting system, the configuration update;
receiving, at the transaction system from the cloud-based tax management and reporting system, updated tax content; or
transmitting, from the transaction system to the cloud-based tax management and reporting system, one or more of compliance data or tax reporting data.

6. The method of claim 1, wherein the local tax engine includes an executable software package that includes one or more tax libraries, one or more entity-specific parameter libraries, one or more user credentials, or a combination thereof.

7. The method of claim 1, wherein obtaining the transaction data includes generating the transaction data at an edge node of the transaction system, and wherein the edge node executes the local tax engine.

8. The method of claim 1, wherein obtaining the transaction data includes receiving the transaction data from a user system associated with the one or more transactions.

9. A system for local and cloud-based tax determination operations, the system comprising:
a memory; and
one or more processors communicatively coupled to the memory, the one or more processors configured to:
obtain transaction data associated with one or more transactions;
execute a local tax engine based on the transaction data to generate tax data representing one or more tax values associated with the one or more transactions;
send the tax data to a cloud-based tax management and reporting system that is remote to the local tax engine;
keep the transaction data in a local store; and
receive an entity level report from the cloud-based tax management and reporting system, the entity level report based at least in part on the tax data.

10. The system of claim 9, wherein the one or more processors are further configured to:
receive serialized invoice objects at a transaction sync client from the local tax engine; and
push the serialized invoice objects to a cloud sync server of the cloud-based tax management and reporting system via an invoice sync service endpoint.

11. The system of claim 10, wherein the invoice sync service endpoint corresponds to a representational state transfer (REST) endpoint exposed by a transactions sync service of the cloud sync server.

12. The system of claim 9, wherein the one or more processors are further configured to import a configuration change from a cloud sync server of the cloud-based tax management and reporting system via a config sync service endpoint.

13. The system of claim 12, wherein the config sync service endpoint corresponds to a representational state transfer (REST) endpoint exposed by a tenant config sync service of the cloud sync server.

14. The system of claim 9, wherein the one or more processors are further configured to receive a user synchronization from a cloud sync server via a user sync service endpoint.

15. The system of claim 14, wherein the user sync service endpoint corresponds to a representational state transfer (REST) endpoint exposed by a tenant user sync service of the cloud sync server.

16. The system of claim 9, wherein the system includes or corresponds to a transaction system of a first enterprise network, and wherein the cloud-based tax management and reporting system is included in a second enterprise network that is different than the first enterprise network.

17. A method for local and cloud-based tax determination operations, the method comprising:
receiving, at a cloud-based tax management and reporting system, tax data from a transaction system, wherein the tax data is generated by a local tax engine associated with the transaction system based on transaction data associated with one or more transactions, wherein the tax data represents one or more tax values associated with the one or more transactions, and wherein the cloud-based tax management and reporting system is remote to the transaction system; and
transmitting, by the cloud-based tax management and reporting system to the transaction system, an entity level report that is based at least in part on the tax data.

18. The method of claim 17, wherein the cloud-based tax management and reporting system includes a remote tax engine that is remote to the local tax engine.

19. The method of claim 18, further comprising performing, by the cloud-based tax management and reporting system, synchronization of the local tax engine with the remote tax engine.

20. The method of claim 19, wherein performing the synchronization includes one or more of:
receiving, from the transaction system at the cloud-based tax management and reporting system, a request for a configuration update;
transmitting, to the transaction system from the cloud-based tax management and reporting system, the configuration update;
transmitting, to the transaction system from the cloud-based tax management and reporting system, updated tax content; or
receiving, from the transaction system at the cloud-based tax management and reporting system, one or more of compliance data or tax reporting data.
